(19) United States
(12) Patent Application Publication
(10) Pub. No.: US 2004/0216972 A1
(43) Pub. Date: Nov. 4, 2004

(54) Lockup device for hydrodynamic torque transmitting device

(75) Inventor: Naoki Tomiyama, Hirakata-shi (JP)

Correspondence Address: SHINJYU GLOBAL IP COUNSELORS, LLP, 1233 20TH STREET, NW, SUITE 700, WASHINGTON, DC, 20036-2680, US

(73) Assignee: Exedy Corporation, Neyagawa-shi (JP)

(21) Appl. No.: 10/825,152

(22) Filed: Apr. 16, 2004

(30) Foreign Application Priority Data
May 1, 2003 (JP) JP 2003-126562
May 7, 2003 (JP) JP 2003-129271
May 9, 2003 (JP) JP 2003-131857

(51) Int. Cl. F16H 45/02

(52) U.S. Cl. 192/3.29; 192/212

(57) ABSTRACT

A lockup device includes a piston, a clutch plate and an annular coupling member. The piston has a pushing portion opposed to a friction surface of a front cover, and an engagement portion projecting from a portion radially outside the pushing portion toward a front cover. The clutch plate is axially movably and non-rotatably engaged with the engagement portion, and has a frictional coupling portion arranged axially between the friction surface and the pushing portion. The coupling member has an axially flexible body fixed to the front cover, and a pressure-contact portion provided at a radially outer end of the body and arranged axially between the frictional coupling portion and the pushing portion. The coupling member also has a pressure-contact portion that is axially movably arranged between the frictional coupling portion and the pushing portion and which divides a space located axially between the front cover and the piston into two spaces located on the front cover side and the piston side, respectively, and an oil aperture that reduces the difference in hydraulic pressure between the two spaces.

### BACKGROUND OF THE INVENTION

1. Field of the Invention

The present invention relates to a lockup device for a hydrodynamic torque transmitting device, and more particularly to a lockup device for a hydrodynamic torque transmitting device that includes a front cover having a friction surface, an impeller fixed to a front cover and forming a fluid chamber filled with working fluid, and a turbine arranged in the fluid chamber and opposed to the impeller.

2. Background Information

A torque converter is a type of hydrodynamic torque transmitting device that serves to transmit torque from an engine to a transmission via working fluid in the interior thereof. The torque converter primarily includes a front cover that receive torque from the engine, an impeller fixed to a transmission side of the front cover and which forms a fluid chamber, a turbine opposed to the engine side of the impeller that serves to output torque to the transmission, and a stator arranged between radially inner portions of the impeller and the turbine that serves to regulate the flow of the working fluid from the turbine toward the impeller. Many types of torque converters having the above structure include lockup devices.

A lockup device is arranged in a space between the turbine and the front cover, and can mechanically couple the front cover to the turbine in order to directly transmit torque from the front cover to the turbine. The lockup device includes a disk-shaped piston which can be pressed against a friction surface of the front cover and releasably coupled thereto, and a damper mechanism that elastically couples the piston and the turbine in a rotational direction. The piston is provided with a pushing portion at the radially outer portion thereof, to which a friction facing opposed to the friction surface of the front cover is fixed.

One type of lockup device having the above structure is a device having three friction surfaces that serve to increase the torque transmission capacity. A lockup device like this having three friction surfaces includes a piston, a clutch member, a damper mechanism and a piston coupling mechanism. The piston is arranged between the front cover and the turbine, includes a pushing portion, and can be axially moved by the pressure of the working fluid. The clutch member is axially movably and non-rotatably attached to the piston, and has a frictional coupling portion which can be pressed to the friction surface of the front cover. Claws formed on the clutch member that serve to attach the piston to the clutch member are fitted into engagement portions formed of axial through holes in the piston. The damper mechanism is arranged on the turbine side of the piston, and elastically couples the turbine and the piston in the rotational direction. The piston coupling mechanism serves to axially movably couple the pushing portion of the piston and the frictional coupling portion of the clutch member to the front cover. The piston coupling mechanism has a pressure-contact member axially arranged between the frictional coupling portion and the pushing portion, and a cylindrical member fixed to the front cover. The pressure-contact member is spline-engaged with the cylindrical member for axial movement, and is non-rotatably supported thereby. This allows the pressure-contact member to be axially movable and rotatable with respect to the frictional coupling portion and the pushing portion.

In the above lockup device, when working fluid is discharged from a space on the engine side of the piston, the hydraulic pressure in the space on the engine side of the piston relatively increases to axially move the piston toward the engine. Thus, the pushing portion of the piston axially pushes the pressure-contact member of the piston coupling mechanism toward the engine, and thus axially moves the pressure-contact member of the piston coupling mechanism toward the engine so that the frictional coupling portion of the clutch member is axially pushed toward the engine. The frictional coupling portion of the clutch member is thereby pressed against the friction surface of the front cover so that the torque of the front cover is transmitted to the piston through the clutch member and the piston coupling mechanism, and is further transmitted via the damper mechanism to the turbine (see, for example, Japanese Unexamined Patent Application Publication No. H10-246307).

In the lockup device described above, the piston coupling mechanism is formed of two members, i.e., the cylindrical member and the pressure-contact member, and therefore requires many parts. Further, the structure is complicated because spline-engagement is utilized between the cylindrical member and the pressure-contact member.

In the lockup device described above, the piston coupling mechanism formed of the cylindrical member and the pressure-contact member is arranged to divide the space on the engine side of the piston into a first hydraulic chamber located on the engine side and a second hydraulic chamber on the transmission side. Thus, when a lockup operation is performed by discharging working fluid from the space on the engine side of the piston, a difference in the discharge rate or flow rate will occur between the discharge from the first hydraulic chamber and the discharge from the second hydraulic chamber. This may impede smooth movement of the pressure-contact member in the axial direction, and may impede a smooth lockup operation. Like during the lockup operation, when the lockup state is released by supplying working fluid into the space on the engine side of the piston, a difference in flow rate between the supply of the working fluid to the first hydraulic chamber and the supply of the working fluid to the second hydraulic chamber will occur and thus the release of the lockup state may not be performed smoothly.

In the lockup device described above, the claws of the clutch member project from the surface on the turbine side of the piston because the clutch member is attached to the piston by fitting the claws of the clutch member into the engagement portions composed of the axial through holes in the piston. Members such as torsion springs and a drive plate forming the damper mechanism are arranged on the turbine-side surface of the piston, and thus may interfere with the claws of the clutch member. This restricts the arrangement of the clutch members, which is not preferable in view of the design of the lockup device.

### SUMMARY OF THE INVENTION

An object of the invention is to provide a lockup device in which a clutch member is attached to a piston to provide three or more friction surfaces, and more particularly to provide a lockup device which requires a reduced number of parts and has a simplified structure.

A second object of the invention is to provide a lockup device in which a clutch member is attached to a piston to provide three or more friction surfaces, and more particularly to provide a lockup device which can smoothly perform a lockup operation and a lockup release operation.

A third object of the invention is to provide a lockup device in which a clutch member is attached to a piston to provide three or more friction surfaces, and more particularly to provide a lockup device which can improve flexibility in the arrangement of the clutch member.

According to a first aspect of the present invention, a lockup device for a hydrodynamic torque transmitting device having a front cover which includes a friction surface, an impeller fixed to the front cover which forms a fluid chamber filled with working fluid, and a turbine arranged in the fluid chamber and opposed to the impeller, is comprised of a piston, a first clutch member and an annular first coupling member. The piston is arranged between the front cover and the turbine, has a pushing portion opposed to the friction surface, and is axially movable in response to pressure of the working fluid. The first clutch member has a first frictional coupling portion attached axially movably and non-rotatably to the piston, and axially arranged between the friction surface and the pushing portion. The first coupling member has a first unit fixed to the front cover and is axially flexible, and a first pressure-contact portion provided at a radial end of the first unit and axially disposed between the first frictional coupling portion and the pushing portion.

In this lockup device, when the pushing portion of the piston axially pushes the first pressure-contact portion, the first unit axially bends to axially move the first pressure-contact portion so that the friction surface of the front cover pushes the first frictional coupling portion of the first clutch member to thereby achieve a lockup state.

In this lockup device, a piston coupling mechanism for coupling the pushing portion of the piston and the first frictional coupling portion of the first clutch member to the front cover in an axially movable state is formed of the first coupling member having the axially flexible first unit fixed to the front cover and the first pressure-contact portion arranged axially between the first frictional coupling portion and the pushing portion. Thus, the number of parts can be reduced, and the structure can be made more simple than a conventional structure.

According to a second aspect of the present invention, the first unit of the lockup device of the hydrodynamic torque transmitting device of the first aspect is fixed to the front cover by caulking.

In this lockup device, because the first coupling member is directly fixed to the front cover without interposing another fixing member, the number of parts can be reduced.

According to a third aspect of the present invention, the first coupling member of the lockup device of the hydrodynamic torque transmitting device of the first or second aspect further includes an inclination prevention mechanism allowing axial movement of the first pressure-contact portion without inclination with respect to the first frictional coupling portion and the pushing portion.

In this lockup device, because the inclination prevention mechanism allows axial movement of the first pressure-contact portion without inclination with respect to the first frictional coupling portion and the pushing portion, it is possible to suppress the occurrence of drag torque between the first pressure-contact portion and each of the first frictional coupling portion and the pushing portion, and to achieve a uniform pressure on a facing surface (improvement of μ-v characteristics).

According to a fourth aspect of the present invention, the inclination prevention mechanism of the lockup device of the hydrodynamic torque transmitting device of the third aspect is comprised of a plurality of first apertures formed in the first unit and aligned in the rotational direction, and a plurality of second apertures formed in the first unit and aligned in the rotational direction. The plurality of second apertures are located radially inside or outside the plurality of first apertures, each have a center in the rotational direction located between the first apertures in the rotational direction, each have opposing ends in the rotational direction that overlap in the radial direction of the device with the ends in the rotational direction of the first apertures, and are disposed such that the first and second apertures are in alternating positions with respect to the radial direction.

In this lockup device, by forming a plurality of first apertures and a plurality of second apertures in the first unit, the portion (low-rigidity portion) located radially between the ends in the rotational direction of the first apertures and the ends in the rotational direction of the second apertures has a lower rigidity in a bending direction than the portion located radially between the central portions, in the rotational direction, of the first apertures and the portion (high-rigidity portion) located radially between the central portions, in the rotational direction, of the second apertures. Therefore, when the first pressure-contact portion moves in the axial direction, the low-rigidity portion axially bends to a larger extent than the high-rigidity portion while axially deforming the first and second apertures, and the high-rigidity portion can maintain a posture close to that when in a free state while being axially moved. Thus, the first unit can axially bend while keeping a posture similar to that when in the free state as a whole so that the first pressure-contact portion can be axially moved without inclination with respect to the first frictional coupling portion and the pushing portion.

According to a fifth aspect of the present invention, the first and second apertures of the lockup device of the hydrodynamic torque transmitting device of the fourth aspect are slit apertures each extending in the rotational direction.

In this lockup device, because the first and second apertures are slit apertures, the rigidity of the low- and high-rigidity portions can be appropriately and easily determined by changing the lengths in the rotational direction of the slit apertures.

According to a sixth aspect of the present invention, the lockup device of the hydrodynamic torque transmitting device according to any one of the first to fifth aspects further includes a restriction mechanism that allows the first unit to bend axially only within a predetermined range.

In this lockup device, because the limiting mechanism limits the first unit to bend axially only within a predetermined range, interference with another member can be prevented.

According to a seventh aspect of the present invention, the lockup device of the hydrodynamic torque transmitting device of the first aspect further includes a second clutch member and an annular second coupling member. The second clutch member is attached axially movably and non-rotatably to the first clutch member, and has a second frictional coupling portion arranged axially between the first frictional coupling portion and the friction surface. The second coupling member has an axially flexible second unit fixed to the front cover, and a second pressure-contact portion provided at a radial end of the second unit and located axially between the first and second frictional coupling portions.

In this lockup device, the first clutch member is engaged with the second clutch member having the second frictional coupling portion, and the second coupling member is arranged axially between the first and second frictional coupling portions so that a structure having five friction surfaces can be achieved. This structure can further increase the torque transmission capacity.

According to an eighth aspect of the present invention, the second unit of the lockup device of the hydrodynamic torque transmitting device of the seventh aspect is fixed to the first unit and the front cover by caulking.

In this lockup device, because the second coupling member is fixed together with the first coupling member and the front cover by caulking, an additional fixing member for fixing the second coupling member to the front cover is not required.

According to a ninth aspect of the present invention, a lockup device for a hydrodynamic torque transmitting device having a front cover having a friction surface, an impeller fixed to the front cover and forming a fluid chamber filled with working fluid, and a turbine arranged in the fluid chamber and opposed to the impeller, is comprised of a piston, a first clutch member, a piston coupling mechanism, and a pressure control mechanism. The piston is arranged between the front cover and the turbine, has a pushing portion opposed to the friction surface, and is axially movable in accordance with a pressure of the working fluid. The first clutch member has a portion located radially outside the pushing portion and attached axially movably and non-rotatably to the piston, and has a first frictional coupling portion arranged axially between the friction surface and the pushing portion. The piston coupling mechanism is arranged at the front cover to divide a space located axially between the front cover and the piston into a first working fluid chamber on a front cover side and a second working fluid chamber on a piston side, has an axially movable first pressure-contact portion arranged axially between the first frictional coupling portion and the pushing portion, and movably couples in the axial direction the pushing portion and the first frictional coupling portion to the front cover. The pressure control mechanism can equalize the pressures in the first and second working fluid chambers.

In this lockup device, because the pressure control mechanism can equalize the pressure in the first and second working fluid chambers formed by the piston coupling mechanism, the lockup device can smoothly discharge and supply working fluid from and to the first and second working fluid chambers. Thus, the first pressure-contact portion of the piston coupling mechanism can move stably in the axial direction, and entering and releasing the lockup state can be performed smoothly.

According to a tenth aspect of the present invention, the pressure control mechanism of the lockup device of the hydrodynamic torque transmitting device of the ninth aspect is an oil passage provided in the piston coupling mechanism for connecting the first and second working fluid chambers to each other.

In this lockup device, the structure thereof can be simplified because the pressure control mechanism includes an oil passage provided in the piston coupling mechanism that serves to connect the first and second working fluid chambers to each other.

According to an eleventh aspect of the present invention, the lockup device of the hydrodynamic torque transmitting device of the ninth aspect further includes a second clutch member attached axially movably and non-rotatably to the first clutch member, and having a second frictional coupling portion arranged axially between the first frictional coupling portion and the friction surface. The piston coupling mechanism further includes an axially movable second pressure-contact portion arranged axially between the first and second frictional coupling portions, and further divides the first working fluid chamber into a third working fluid chamber on the front cover side and a fourth working fluid chamber on the piston side. The pressure control mechanism can equalize the pressures in the third, fourth and second working fluid chambers.

In this lockup device, the first clutch member is engaged with the second clutch member having the second frictional coupling portion, and the second pressure-contact portion is arranged axially between the first and second frictional coupling portions. Thus, a structure having five friction surfaces is achieved, and the torque transmission capacity will be further increased.

Even with this configuration, because the pressure control mechanism can equalize the pressures in the third and fourth working fluid chambers respectively formed on the front cover side and the piston side as a result of the arrangement of the second pressure-contact portion, the first and second pressure-contact portions of the piston coupling mechanism can move stably in the axial direction, and entering into and releasing the lockup state can be smoothly performed.

According to a twelfth aspect of the present invention, a lockup device for a hydrodynamic torque transmitting device having a front cover having a friction surface, an impeller fixed to the front cover and forming a fluid chamber filled with working fluid, and a turbine arranged in the fluid chamber and opposed to the impeller, is comprised of a piston, a damper mechanism, a first clutch member and a piston coupling mechanism. The piston is arranged between the front cover and the turbine, has a pushing portion opposed to the friction surface and an engagement portion projecting toward the front cover from a portion radially outside the pushing portion, and is axially movable in response to the pressure of the working fluid. The damper mechanism is arranged on the turbine side of the piston for elastically coupling the turbine and the piston together. The first clutch member is axially movably and non-rotatably engaged with the engagement portion, and has a first frictional coupling portion arranged axially between the friction surface and the pushing portion. The piston coupling mechanism is provided at the front cover, has an axially movable first pressure-contact portion arranged axially between the first frictional coupling portion and the pushing portion, and axially movably couples the pushing portion and the first frictional coupling portion to the front cover.

In this lockup device, because the engagement portion is formed to project toward the front cover, the first clutch member can be attached to the piston without projecting the first clutch member toward the turbine side of the piston. This structure can prevent interference of the first clutch member with components of the damper mechanism arranged on the turbine side of the piston so that flexibility in arrangement of the first clutch member can be improved.

According to a thirteenth aspect of the present invention, the damper mechanism of the lockup device of the hydrodynamic torque transmitting device of the twelfth aspect further includes a drive plate fixed to the piston, a driven plate arranged for rotation with the turbine, and an elastic member supported by a surface on the turbine side of the piston and compressible in a rotational direction between the drive and driven plates. The engagement portion is formed to correspond to a radial position of a portion of the elastic member supported by the piston.

In this lockup device, because the engagement portion is formed in the same radial position as the portion of the elastic member supported by the piston, both the first clutch member and the elastic member can be arranged on the radially outer portion of the piston. This can improve the torsional vibration absorbing characteristics of the damper mechanism, and can further increase the torque transmission capacity.

According to a fourteenth aspect of the present invention, the lockup device of the hydrodynamic torque transmitting device of the twelfth or thirteenth aspect further has such a feature that the engagement portions are formed in a plurality of positions aligned in the rotational direction, respectively.

According to a fifteenth aspect of the present invention, the lockup device of the hydrodynamic torque transmitting device of the twelfth, thirteenth or fourteenth aspects further includes a second clutch member attached axially movably and non-rotatably to the first clutch member and having a second frictional coupling portion arranged axially between the first frictional coupling portion and the friction surface. The piston coupling mechanism further includes an axially movable second pressure-contact portion arranged axially between the first and second frictional coupling portions.

In this lockup device, a structure having five friction surfaces is achieved by engaging the second clutch member having the second frictional coupling portion with the first clutch member, and arranging the second pressure-contact portion axially between the first and second frictional coupling portions. This allows the torque transmission capacity to be further increased.

As described above, the lockup device according to the present invention has three or more friction surfaces owing to attachment of the clutch member to the piston. In this lockup device, the piston coupling mechanism includes the coupling member having an axially flexible body and a pressure-contact portion, and this coupling member axially movably couples the pushing portion of the piston and the frictional coupling portion of the clutch member to the front cover. Therefore, the number of parts can be reduced, and the structure can be simplified.

In addition, the lockup device according to the present invention has three or more friction surfaces owing to attachment of the clutch member to the piston, and is configured such that the pressure control mechanism decreases the pressure differential between the first and second working fluid chambers formed as a result of the provision of the piston coupling mechanism, and thus stabilizes the axial movement of the first pressure-contact portion of the piston coupling mechanism. Therefore, entering into and releasing the lockup state can be performed smoothly.

Moreover, the lockup device according to the invention has three or more friction surfaces owing to attachment of the clutch member to the piston, and is configured such that the engagement portion of the clutch member formed on the piston projects toward the front cover so that the piston can be attached without projecting the clutch member from the surface on the turbine side of the piston. This can improve flexibility in the arrangement of the clutch member.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a schematic cross section of a torque converter employing a lockup device according to a first embodiment of the invention;

FIG. 2 is a enlarged fragmentary view showing the lockup device in FIG. 1;

FIG. 3 shows the transmission side of an assembly formed of a drive plate, torsion springs and a piston of the lockup device according to the first embodiment;

FIG. 4 shows the engine side of an assembly formed from the clutch plate and the piston of the lockup device according to the first embodiment;

FIG. 5 shows a lockup device according to a modification of the first embodiment of the present invention;

FIG. 6 shows a lockup device according to a second embodiment of the invention;

FIG. 7 shows the transmission side of a coupling member of the lockup device of the second embodiment;

FIG. 8 schematically illustrates operation of the coupling member of the lockup device of the second embodiment, and includes a view (a) showing an section taken along line A-A in FIG. 7, a view (b) showing a section taken along line B-B in FIG. 7 and a view (c) showing a coupling member that does not including an inclination prevention mechanism;

FIG. 9 schematically illustrates operations of the coupling member of the lockup device of the second embodiment, and includes a view (a) showing a section taken along line C-C in FIG. 7 and a view (b) showing a section taken along line D-D in FIG. 7;

FIG. 10 is a view showing a modification of the lockup device according to the second embodiment of the present invention;

FIG. 11 is a view showing a lockup device according to a third embodiment of the invention;

FIG. 12 is a view showing a first modification of the lockup device of the third embodiment of the present invention;

FIG. 13 is a view showing a second modification of the lockup device of the third embodiment of the present invention;

FIG. 14 is a view showing a third modification of the lockup device of the third embodiment of the present invention;

FIG. 15 is a view showing a lockup device according to a fourth embodiment of the invention;

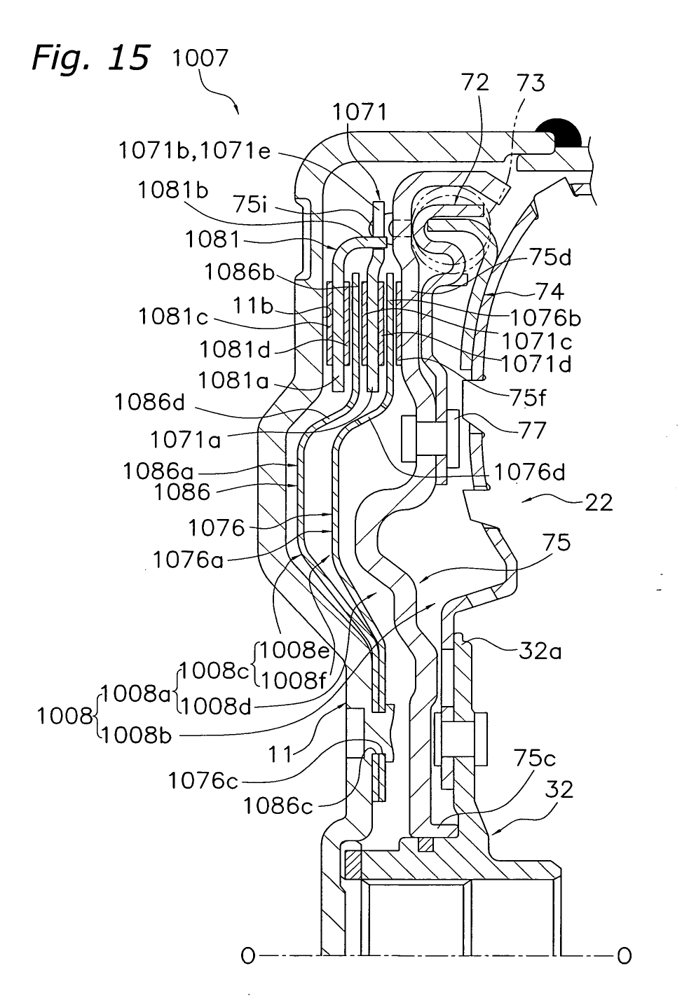

FIG. 16 shows the engine side of an assembly formed from two clutch plates and a piston of the lockup device of the fourth embodiment; and

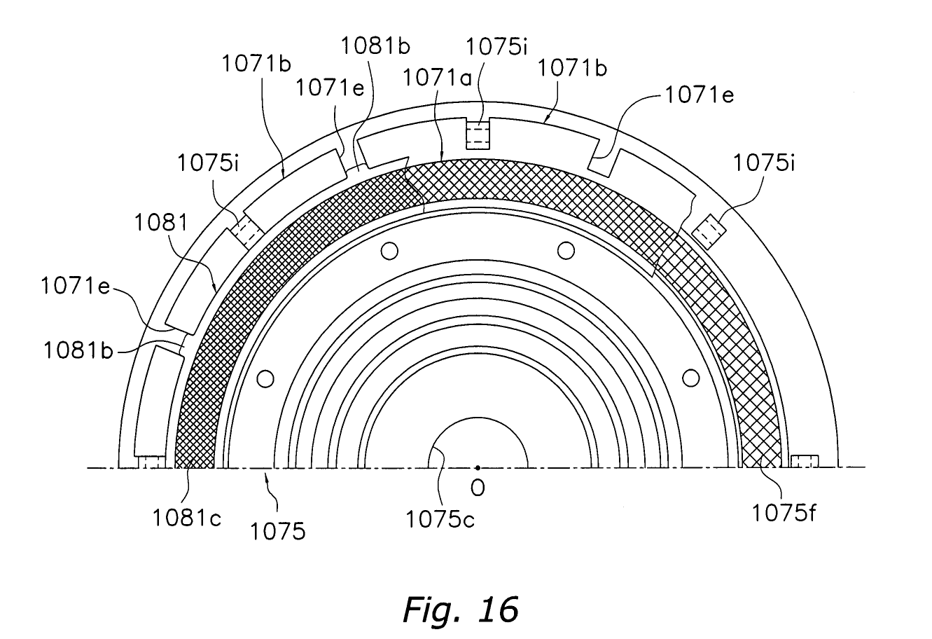

FIG. 17 is a view showing a modification of the lockup device of the fourth embodiment of the present invention.

### DETAILED DESCRIPTION OF THE PREFERRED EMBODIMENTS

Embodiments of the invention will now be described with reference to the figures.

First Embodiment

(1) Overall Structure Of The Torque Converter

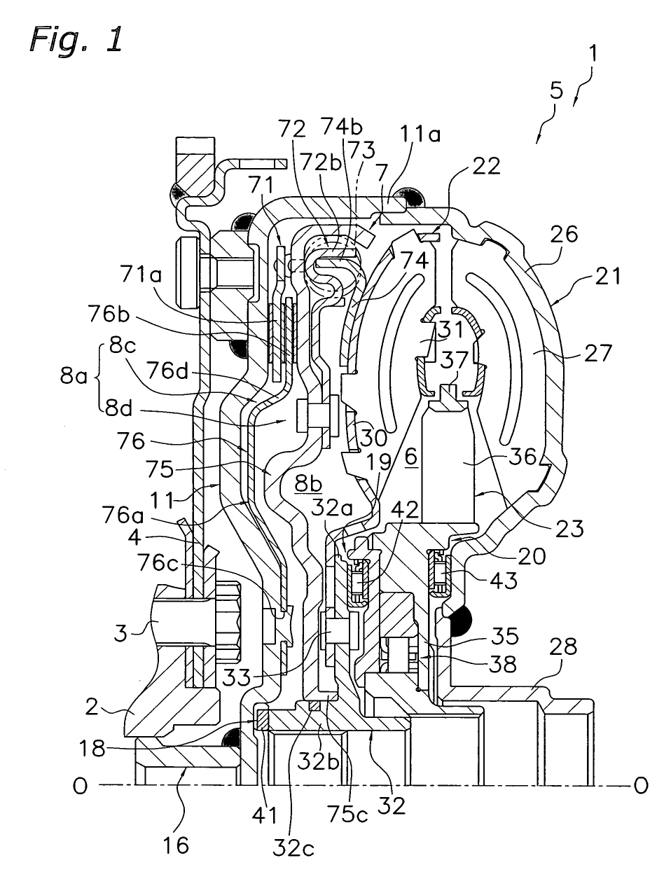

FIG. 1 is a schematic cross section of a torque converter 1, which is a hydrodynamic torque transmitting device employing a lockup device according to a first embodiment of the invention. The torque converter 1 is a device for transmitting torque from a crankshaft 2 of an engine to an input shaft (not shown) of a transmission. The engine (not shown) is arranged on the left side in FIG. 1, and the transmission (not shown) is arranged on the right side in FIG. 1. In FIG. 1, O-O represents the rotation axis of the torque converter 1.

The torque converter 1 is primarily formed of a flexible plate 4 and a torque converter body 5. The flexible plate 4 is formed of a thin circular member, and serves to transmit torque and absorb bending vibrations transmitted from the crankshaft 2 to the torque converter body 5. Therefore, the flexible plate 4 has sufficient rigidity for torque transmission in the rotational direction, but low rigidity in the bending direction. The radially inner portion of the flexible plate 4 is fixed to the crankshaft 2 by crank bolts 3.

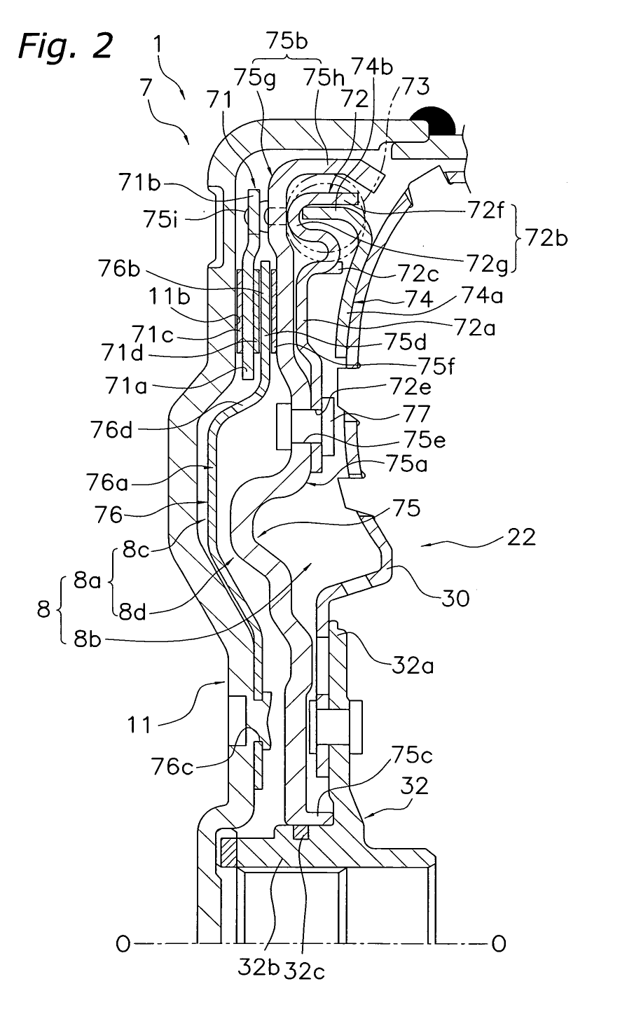

The torque converter body 5 includes a front cover 11 to which a radially outer portion of the flexible plate 4 is fixed, three types of vanes (i.e., an impeller 21, a turbine 22 and a stator 23), and a lockup device 7. A fluid chamber which is surrounded by the front cover 11 and the impeller 21 and filled with working fluid is divided into a torus-shaped fluid operation chamber 6 surrounded by the impeller 21, turbine 22 and stator 23, and an annular space 8 (see FIG. 2) in which the lockup device 7 is arranged.

The front cover 11 is a circular disk-shaped member, and a substantially cylindrical center boss 16 extending in the axial direction is fixed to the radially inner portion of the front cover 11 by welding. The center boss 16 is fitted into a central aperture in the crankshaft 2.

The front cover 11 is provided at its outer peripheral portion with a radially outer cylindrical portion 11a that extends toward the transmission. An outer periphery of an impeller shell 26 of the impeller 21 is fixed to the end of the radially outer cylindrical portion 11a by welding or the like. The front cover 11 and the impeller 21 form a fluid chamber filled with working fluid.

The impeller 21 is primarily formed from the impeller shell 26, a plurality of impeller blades 27 fixed to the inner side of the impeller shell 26, and an impeller hub 28 fixed to the radially inner portion of the impeller shell 26 by welding or the like.

The turbine 22 is arranged in the fluid chamber, and is axially opposed to the impeller 21. The turbine 22 is primarily formed from a turbine shell 30, a plurality of turbine blades 31 fixed to the surface of the turbine shell 30 opposed to the impeller 21, and a turbine hub 32 fixed to the inner periphery of the turbine shell 30. The turbine hub 32 is formed from a flange 32a and a boss 32b. The turbine shell 30 is fixed to the flange 32a of the turbine hub 32 by a plurality of rivets 33. The boss 32b of the turbine hub 32 is provided at its inner peripheral surface with a spline for engagement with the input shaft (not shown). Thus, the turbine hub 32 rotates together with the input shaft (not shown).

The stator 23 is arranged axially between the radially inner portions of the impeller 21 and the turbine 22, and serves to regulate the flow of the working fluid from the turbine 22 toward the impeller 21. The stator 23 has an integral structure formed by molding or casting resin, aluminum alloy or the like, and is primarily formed from an annular stator carrier 35, a plurality of stator blades 36 arranged on the outer peripheral surface of the stator carrier 35, and an annular stator core 37 fixed to radially outer ends of the stator blades 36. The stator carrier 35 is supported on a fixed cylindrical shaft (not shown) via a one-way clutch 38.

A first thrust bearing 41 is arranged axially between the center boss 16 and the turbine hub 32, and bears the thrust caused by the rotation of the turbine 22. A first port 18 that allows working fluid to flow to both sides in the radial direction is formed in the portion where the first thrust bearing 41 is arranged. A second thrust bearing 42 is arranged between the turbine hub 32 (more specifically, flange 32a) and the radially inner portion (more specifically, the one-way clutch 38) of the stator 23. A second port 19 that allows working fluid to flow to both sides in the radial direction is formed in the portion where the second thrust bearing 42 is arranged. Furthermore, a third thrust bearing 43 is arranged axially between the stator 23 (more specifically, the stator carrier 35) and the impeller 21 (more specifically, the impeller hub 28). A third port 20 that allows working fluid to flow to both sides in the radial direction is formed in the portion where the third thrust bearing 43 is arranged. The ports 18-20 are connected to a hydraulic circuit 20 (not shown), and working fluid can be supplied to and discharged from each of the ports 18-20 independent of each other.

(2) Structure of the Lockup Device

The lockup device 7 is arranged in the space 8 between the turbine 22 and the front cover 11, and serves to mechanically couple the turbine 22 and the front cover 11 in accordance with need.

The lockup device 7 functions as a clutch mechanism and a damper mechanism, and is primarily formed from a clutch plate 71, a drive plate 72, torsion springs 73, a driven plate 74, a piston 75 and a coupling member 76.

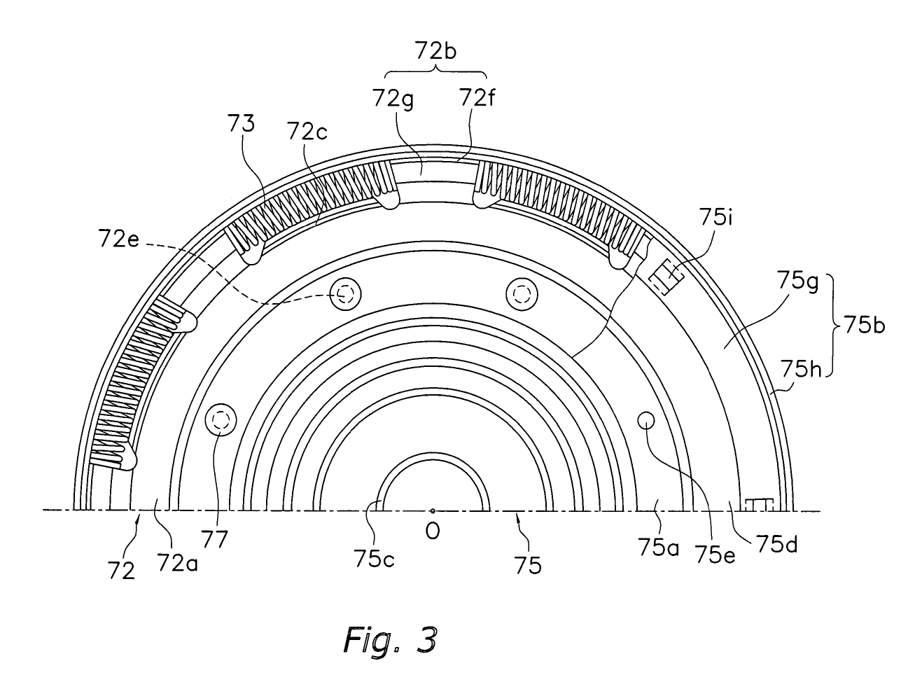

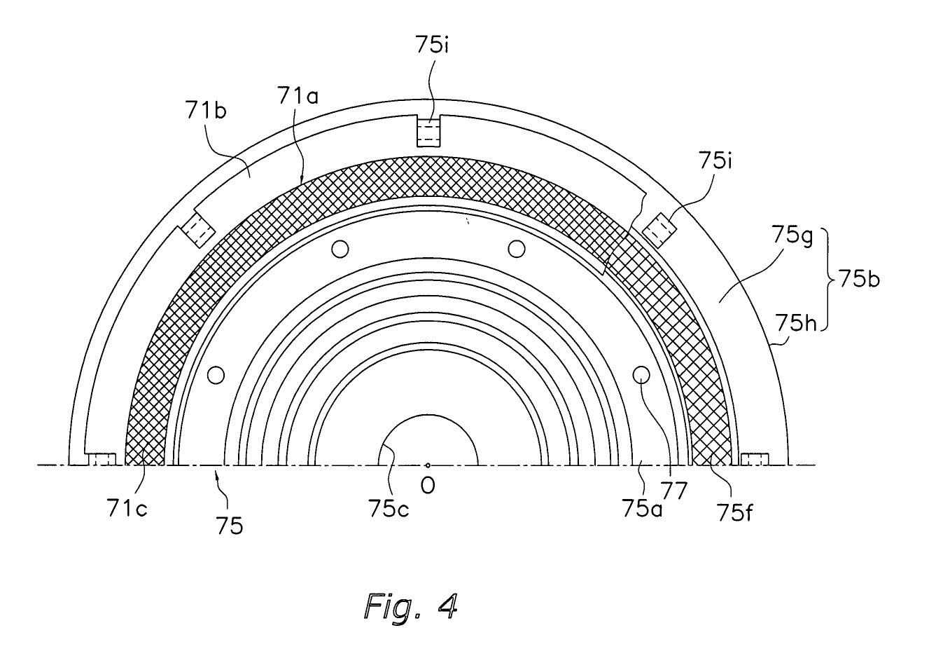

The lockup device 7 will now be described in greater detail with reference to FIGS. 2 to 4. FIG. 2 is a fragmentary view showing, on an enlarged scale, the lockup device 7 in FIG. 1. FIG. 3 is a view of the transmission side of an assembly composed of the drive plate 72, the plurality of torsion springs 73, and the piston 75, with certain parts cut away in order to show the piston 75. FIG. 4 is a view of the engine side of an assembly composed of the clutch plate 71 and the piston 75, with certain parts cut away in order to show the piston 75.

(2-1) Piston

The piston 75 is a disk-shaped member having a central aperture. The piston 75 is arranged around the boss 32b of the turbine hub 32. The piston 75 is primarily formed of a disk-shaped portion 75a, a spring support portion 75b formed radially outside the disk-shaped portion 75a and a radially inner cylindrical portion 75c formed radially inside the disk-shaped portion 75a.

The disk-shaped portion 75a is arranged to divide the space 8 into a space 8a on the engine side and a space 8b on the transmission side, and has a pushing portion 75d formed at its radially outer portion and a plurality of fixing apertures 75e formed radially inside the pushing portion 75d. The pushing portion 75d is an annular portion providing a flat surface on the front cover side, and an annular friction facing 75f is fixed to this side surface. The fixing apertures 75e are provided for fixing the drive plate 72 to the piston 75 by means of rivets 77 fitted therein, and are respectively formed at eight positions spaced from each other in the rotational direction in this embodiment.

The spring support portion 75b supports portions of the torsion springs 73 on the engine side and a radially outer portion thereof, and has a radially outer annular portion 75g in contact with the engine side portion of each torsion spring 73 and a radially outer cylindrical portion 75h extending axially toward the transmission from the outer periphery of the radially outer annular portion 75g. The radially outer annular portion 75g is an annular portion extending radially outward from the outer periphery of the disk shaped portion 75a, and has engagement portions 75i projecting axially toward the engine. In this embodiment, two circumferentially spaced slits (i.e., slits spaced apart in the rotational direction) are formed in a portion of the radially outer annular portion 75g, and a portion between these two slits is pushed outward axially toward the engine to form each of the engagement portions 75i. Thus, the engagement portions 75i can suppress lowering of the rigidity of the radially outer annular portion 75g, in contrast to the case where they are formed by recessing the radially outer annular portion 75g, and cutting and removing a part of the radially outer annular portion 75g. In this embodiment, the engagement portions 75i are formed at a plurality of (eight in this embodiment) circumferentially spaced positions (i.e., positions spaced apart in the rotational direction) of the radially outer annular portion 75g, respectively. The radially outer cylindrical portion 75h has an end portion on the transmission side that converges toward the center.

The radially inner cylindrical portion 75c axially extends from the inner periphery of the disk-shaped portion 75a toward the transmission, and the inner peripheral surface thereof is supported axially movably and rotatably on the outer peripheral surface of the boss 32b of the turbine hub 32. A seal ring 32c is arranged between the outer peripheral surface of the boss 32b and the inner peripheral surface of the radially inner cylindrical portion 75c. The seal ring 32c seals the portion radially inside the piston 75 to isolate the spaces 8a and 8b from each other.

(2-2) Drive Plate

The drive plate 72 is an annular plate member serves to support the plurality of torsion springs 73 together with the piston 75, and is arranged on the transmission side of the piston 75. The drive plate 72 has a radially inner portion fixed to the disk-shaped portion 75a of the piston 75 by the plurality of rivets 77 for rotation together with the piston 75.

The drive plate 72 is primarily formed of a first annular portion 72a, a plurality of first claws 72b formed at the outer periphery of the first annular portion 72a and a plurality of second claws 72c formed circumferentially between the first claws 72b.

The first annular portion 72a is provided at its radially inner portion with a plurality of fixing apertures 72e. The rives 77 pass through the fixing apertures 72e, serve to fix the drive plate 72 to the piston 75, and are respectively arranged at eight circumferentially spaced positions corresponding to the fixing apertures 75e in the piston 75.

The first claws 72b are arranged in the space on the transmission side of the spring support portion 75b of the piston 75. The first claws 72b in this embodiment are respectively formed in the eight circumferentially spaced positions. More specifically, the first claw 72b has a second annular portion 72g extending radially outward along the surface on the transmission side of the radially outer annular portion 75g of the piston 75, and a cylindrical portion 72f extending axially toward the transmission from the radially outer end of the second annular portion 72g.

The second claws 72c are formed by partially cutting and bending the outer peripheral portion of the first annular portion 72a toward the transmission, and are respectively located in eight circumferentially spaced positions in this embodiment.

(2-3) Torsion Spring

In this embodiment, there are eight torsion springs 73, are made of coil springs, and are respectively arranged to correspond to positions that are circumferentially between the first claws 72b of the drive plate 72. The circumferential ends of the first claws 72b support directly or through spring seats the circumferentially opposite ends of each torsion spring 73, i.e., the opposite ends in the rotational direction, respectively. In addition, the spring support portion 75b (more specifically, the radially outer annular portion 75g and the radially outer cylindrical portion 75h) of the piston 75 supports the portion on the engine side of each torsion spring and the radially outer portion thereof. Further, the second claw 72c of the drive plate 72 supports the radially inner portion of the torsion spring 73. In this manner, the torsion spring 73 is supported by the piston 75 and the drive plate 72.

In this embodiment, each engagement portion 75i formed at the spring support portion 75b of the piston 75 is arranged to correspond to the radial positions of the first claw 72b of the drive plate 72 and the torsion spring 73 (more specifically, corresponding to the second annular portion 72g of the first claw 72b). However, the engagement portion 75i axially projects toward the engine as already described so that it does not interfere with the first claws 72b and the torsion springs 73.

(2-4) Driven Plate

The driven plate 74 rotates together with the turbine 22, can rotate relatively to the drive plate 72, and is arranged on the transmission side of the drive plate 72. In this embodiment, the driven plate 74 has an annular portion 74a, which is fixed to the surface on the engine side of the radially outer portion of the turbine shell 30 by welding or the like, and a plurality of claws 74b. Each claw 74b extends axially toward the engine from the outer periphery of the annular portion 74a, and is in contact with the circumferential end, i.e., the end in the rotational direction of the torsion spring 73. In this embodiment, the claw 74b is located radially inside the cylindrical portion 72f of the first claw 72b of the drive plate 72, extends axially toward the engine, and has an end near the second annular portion 72g of the first claw 72b of the drive plate 72. The claws 74b are located in substantially the same circumferential or angular positions as the first claws 72b of the drive plate 72, respectively, so that each torsion spring 73 can be compressed in the rotational direction between the claw 74b and the first claw 72b of the drive plate 72.

In the above structure, the drive plate 72, torsion springs 73 and driven plate 74 form a damper mechanism of the lockup device 7 for elastically coupling the piston 75 to the turbine 22.

(2-5) Clutch Plate

The clutch plate 71 is axially movably and non-rotatably attached to the piston 75. The clutch plate 71 is an annular plate member arranged on the engine side of the piston 75, and has an annular frictional coupling portion 71a neighboring to a friction surface 11b of the front cover 11 and a plurality of claws 71b formed radially outside the frictional coupling portion 71a.

An annular friction facing 71c is attached to the surface on the engine side of the frictional coupling portion 71a. In this embodiment, an annular friction facing 71d is attached to the surface on the transmission side of the frictional coupling portion 71a.

The claws 71b are engageable with the engagement portions 75i of the spring support portion 75b of the piston 75, and are axially movable and non-rotatable with respect to the engagement portions 75i. In this embodiment, the claws 71b are formed on both sides in the rotational direction of the engagement portions 75i by recessing portions that correspond to the engagement portions 75i. Thus, the clutch plate 71 is engaged with the piston 75 by engaging the two claws 71b with the circumferentially opposite sides of each engagement portion 75i.

(2-6) Coupling Member

The coupling member 76 functions as a piston coupling mechanism to axially movably couple the pushing portion 75d of the piston 75 and the frictional coupling portion 71a of the clutch plate 71 to the front cover 11.

The coupling member 76 is an axially flexible plate member, and is primarily formed of a body 76a and a pressure-contact portion 76b arranged axially between the frictional coupling portion 71a and the pushing portion 75d. The coupling member 76 is made of, e.g., an elastically deformable material such as spring steel.

In this embodiment, the body 76a is an annular portion dividing the space 8a located axially between the front cover 11 and the piston 75 into a space 8c on the engine side and a space 8d on the transmission side, and has a plurality of fixing apertures 76c and a plurality of oil apertures 76d. The fixing apertures 76c are formed at the radially inner portion of the body 76a. The coupling member 76 is fixed to the front cover 11 by caulking effected at the positions of these fixing apertures 76c so that it can rotate together with the front cover 11. The oil apertures 76d are provided in order to continuously allow working fluid to flow between the spaces 8c and 8d, and are formed at the radially outer portion of the body 76a in this embodiment.

The pressure-contact portion 76b is an annular portion formed radially outside the body 76a, and is arranged axially between the surface on the transmission side of the frictional coupling portion 71a of the clutch plate 71 (more specifically, the friction facing 71d) and the pushing portion 75d of the piston 75 (more specifically, the friction facing 75f). The pressure-contact portion 76b can axially move when the body 76a axially bends around a position of the fixing aperture 76c.

As described above, the coupling member 76 is non-rotatable with respect to the front cover 11, and can move axially in accordance with the axial movement of the pushing portion 75d of the piston 75 and the frictional coupling portion 71a of the clutch plate 71 so that the coupling member 76 is axially pressed between the frictional coupling portion 71a and the pushing portion 75d, and thus can couple the piston 75 to the front cover 11.

As described above, the clutch plate 71 as well as the pushing portion 75d of the piston 75 and the coupling member 76 form the clutch mechanism of the lockup device 7 for frictionally coupling the front cover 11 to the piston 75.

(3) Operation of the Torque Converter And the Lockup Device

The operation of the torque converter 1 will now be described with reference to FIGS. 1 and 2.

Immediately after start of the engine, working fluid is supplied into the torque converter body 5 through the first and third ports 18 and 20, and is discharged through the second port 19. The working fluid supplied from the first port 18 flows radially outward in the space 8a. Working fluid further flows through spaces on the axially opposite sides of the frictional coupling portion 71a of the clutch plate 71 and spaces on the axially opposite sides of the pressure-contact portion 76b of the coupling member 76, and finally flows into the fluid operation chamber 6.

In the above operation, the pressure in the space 8a is higher than the pressure in the space 8b and the fluid operation chamber 6 so that the piston 75 moves axially toward the transmission. The piston 75 stops when the end on the turbine side of the radially inner cylindrical portion 75c comes into contact with the surface on the engine side of the flange 32a. Thus, when the device is not in the lockup state, torque transmission is performed between the front cover 11 and the turbine 22 by means of the torque drive between the impeller 21 and the turbine 22.

When the speed ratio of the torque converter 1 rises and the rotation speed of the input shaft (not shown) reaches a predetermined value, the working fluid is discharged from the space 8a through the first port 18. Consequently, the pressure in the fluid operation chamber 6 and the space 8b exceeds the pressure in the space 8a, and the piston 75 axially moves toward the engine. Thus, the pushing portion 75d of the piston 75 axially pushes the pressure-contact portion 76b of the coupling member 76 toward the engine, and the body 76a of the coupling member 76 axially bends toward the engine around the position of the fixing aperture 76c. Consequently, the pressure-contact portion 76b of the coupling member 76 axially moves toward the engine so that it comes into contact with the frictional coupling portion 71a of the clutch plate 71, and is axially held between the pushing portion 75d and the frictional coupling portion 71a. Further, the pushing portion 75d of the piston 75 axially pushes the frictional coupling portion 71a toward the engine while holding the pressure-contact portion 76b between the pushing portion 75d and the frictional coupling portion 71a, and thus the frictional coupling portion 71a is pressed against the friction surface 11b of the front cover 11. The lockup operation is performed in this manner.

In the above operation, the clutch plate 71 moves smoothly in the axial direction because it is axially movably and non-rotatably engaged with the engagement portions 75i of the piston 75. Because the coupling member 76 rotates together with the front cover 11, the coupling member 76 transmits the torque to the clutch plate 71 and the piston 75. The torque transmitted from the front cover 11 to the piston 75 is then transmitted to the turbine 22 through the damper mechanism rotating together with the piston 75 (i.e., through the drive plate 72, torsion springs 73 and driven plate 74), and is directly provided to the input shaft (not shown). In this operation, the drive plate 72 rotates relatively to the driven plate 74 so that the torsion springs 73 are compressed between the circumferential ends of the first claws 72b of the drive plate 72 and the circumferential ends of the claws 74b of the driven plate 74.

Because the body 76a of the coupling member 76 is provided with the oil aperture 76d, a flow of working fluid between the spaces 8c and 8d will be ensured, and the pressures in the spaces 8c and 8d will be equalized. Thus, working fluid can be smoothly discharged from the space 8c when the device is in the lockup state.

Releasing the lockup state will now be described. In the lockup release operation, similar to immediately after the start of the engine, working fluid is supplied into the torque converter body 5 through the first and third ports 18 and 20, and working fluid is discharged through the second port 19. Thus, working fluid supplied from the first port 18 flows radially outward in the space 8a. Working fluid further flows through the spaces on the axially opposite sides of the frictional coupling portion 71a of the clutch plate 71 and the spaces on the axially opposite sides of the pressure-contact portion 76b of the coupling member 76, and finally flows into the fluid operation chamber 6.

In this operation, the pressure in the space 8a exceeds the pressure in the space 8b and the fluid operation chamber 6, so the piston 75 moves axially toward the transmission. The piston 75 moves until the end on the turbine side of the radially inner cylindrical portion 75c comes into contact with the surface on the engine side of the flange 32a of the turbine hub 32. Because the pushing force which has been acting axially toward the engine is released, the pressure-contact portion 76b moves axially toward the transmission, and the body 76a which has been bent axially toward the engine is released from the bent state and returns to the free state.

In this lockup release operation, working fluid is smoothly supplied into the space 8c because the body 76a of the coupling member 76 is provided with the oil aperture 76d.

In the lockup device 7, the friction facings 71c and 71d are fixed to the opposite surfaces of the frictional coupling portion 71a of the clutch plate 71, respectively, and the friction facing 75f is fixed to the pushing portion 75d of the piston 75 so that the torque transmission capacity is larger than that of a lockup device having one or two friction surface(s).

(4) Special Features of the Lockup Device

The lockup device 7 of this embodiment has the following special features.

(4-1) The pushing portion 75d of the piston 75 and the frictional coupling portion 71a of the clutch plate 71 are axially movably coupled to the front cover 11 by means of the piston coupling mechanism formed from the axially flexible body 76a and the coupling member 76 having the pressure-contact portion 76b arranged at the radial end of the body 76a. Therefore, compared to a conventional lockup device having three friction surfaces, the lockup device 7 requires a reduced number of parts and has a simplified structure.

(4-2) The coupling member 76 is provided with the plurality of oil apertures 76d to ensure a flow of working fluid between the spaces 8c and 8d so that the pressure in these spaces are equalized. Thus, working fluid is smoothly supplied and discharged to and from the space 8c when entering into and releasing the lockup state, and thus responsiveness is improved when entering into and releasing the lockup state.

(4-3) The clutch plate 71 is axially movably and non-rotatably engaged with the spring support portion 75b of the piston 75 through the engagement portions 75i which project axially toward the engine. Therefore, the clutch plate 71 is prevented from interference with the members arranged near the surface of the transmission side of the piston 75 (more specifically, the drive plate 72 and the torsion springs 73) so that flexibility in the arrangement of the clutch plate 71 will be improved.

In particular, even in a structure having the engagement portions 75i arranged on the radially outer portion of the piston 75 (more specifically, in the same radial position as the torsion springs 73), as in the above embodiment, interference does not occur between the engagement portion 75i and the torsion spring 73, and thus the friction surface 11b, frictional engagement portion 71a and the pushing portion 75d can be arranged in the radially outer positions without difficulty. Thus, the torsional vibration absorbing characteristics of the damper mechanism of the lockup device 7 can be improved, and the torque transmission capacity can be further increased.

(5) Modifications

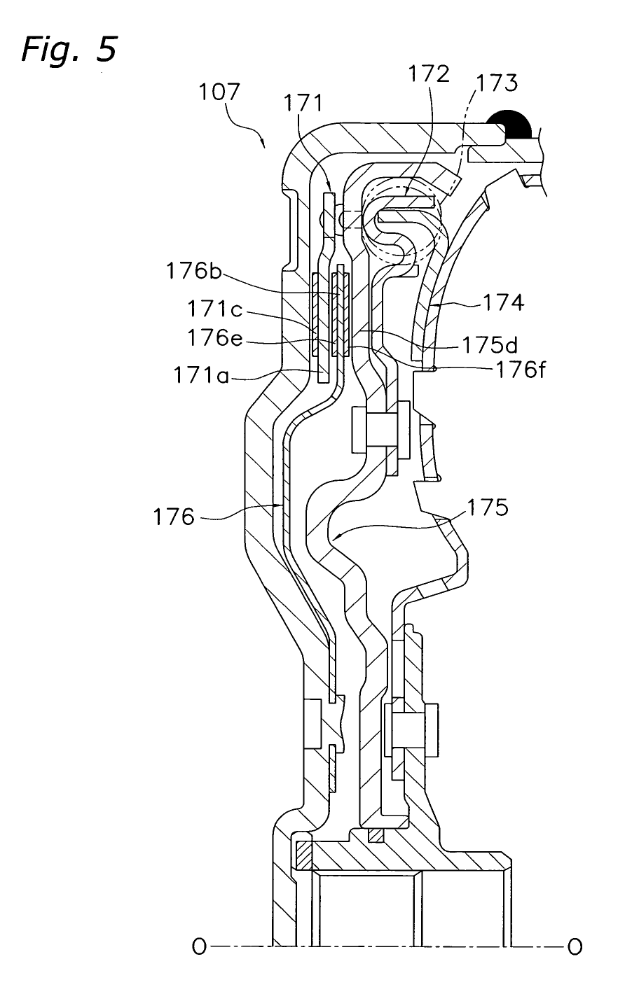

In the lockup device 7 of the above embodiment, the friction facings 71c, 71d and 75f are attached to the surfaces on the engine side and the transmission side of the frictional coupling portion 71a as well as the pushing portion 75d of the piston 75. However, the structure of the lockup device 7 is not limited to this, and a lockup device 107 having the modifications shown in FIG. 5 may also be employed. In the lockup device 107, friction facings 171c, 176e and 176f are fixed to a surface on the engine side of a frictional coupling portion 171a and surfaces of a pressure-contact portion 176d of a coupling member 176. The structure of the lockup device 107 other than the above are the same as those of the lockup device 7, and therefore will not be described here.

The lockup device 107 described above can achieve effects similar to those of the lockup device 7.

Second Embodiment

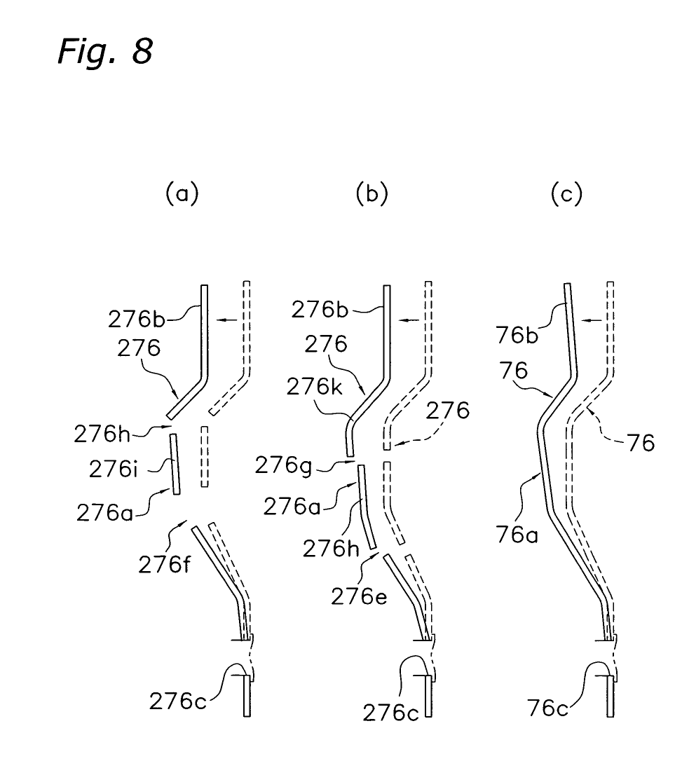

In the lockup device 7 of the first embodiment, because the body 76a of the coupling member 76 axially bends around the radial position of the fixing aperture 76c, the pressure-contact portion 76b inclines with respect to the frictional coupling portion 71a and the pushing portion 75d, as shown in FIG. 8(c), when it axially moves during a lockup operation. In FIG. 8(c), the dotted line represents the coupling member 76 when released from the lockup state, and the solid line represents the coupling member 76 in the lockup state.

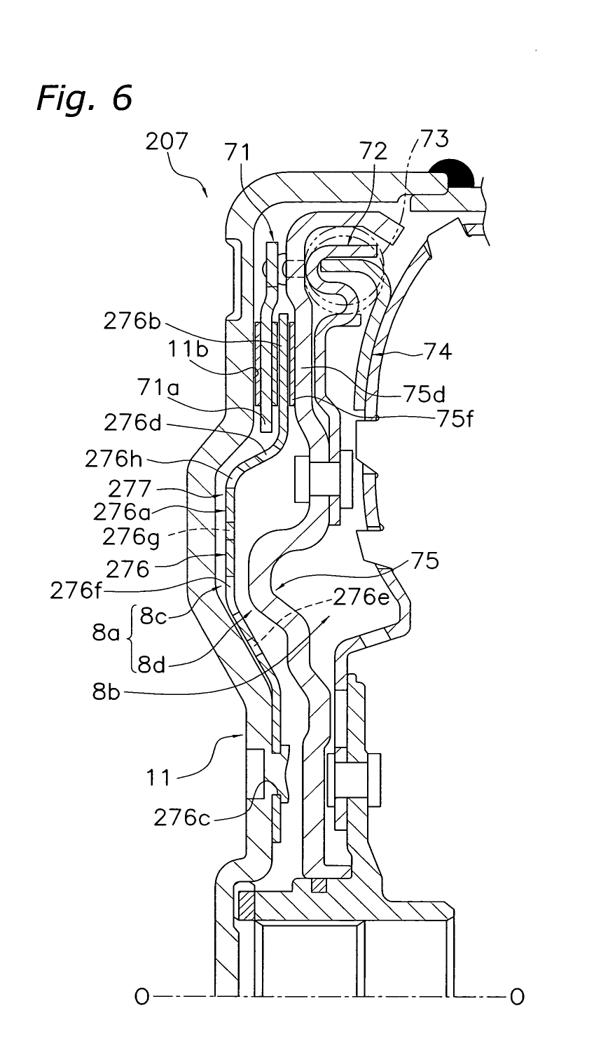

In contrast to the above, a lockup device 207 according to a second embodiment shown in FIG. 6 includes a coupling member 276, which is provided with an inclination prevention mechanism 277 for axially moving a pressure-contact portion 276b while preventing inclination with respect to the frictional coupling portion 71a and the pushing portion 75d. The lockup device 207 of the second embodiment will now be described. The structure of the lockup device 207 other than the coupling member 276 are substantially the same as those of the lockup device 7, and thus the same portions as those in the first embodiment will not be described herein.

(1) Structure and Operation of the Coupling Member

Similar to the coupling member 76 in the first embodiment, the coupling member 276 is an axially flexible plate member, and is primarily formed of a body 276a, a frictional coupling portion 71a and a pressure-contact portion 276b arranged axially between the frictional coupling portion 71a and the pushing portion 75d.

The body 276a in this embodiment is an annular portion further dividing the space 8a formed axially between the front cover 11 and the piston 75 into the space 8c on the engine side and the space 8d on the transmission side, and has a plurality of fixing apertures 276c, a plurality of oil apertures 276d and the inclination prevention mechanism 277.

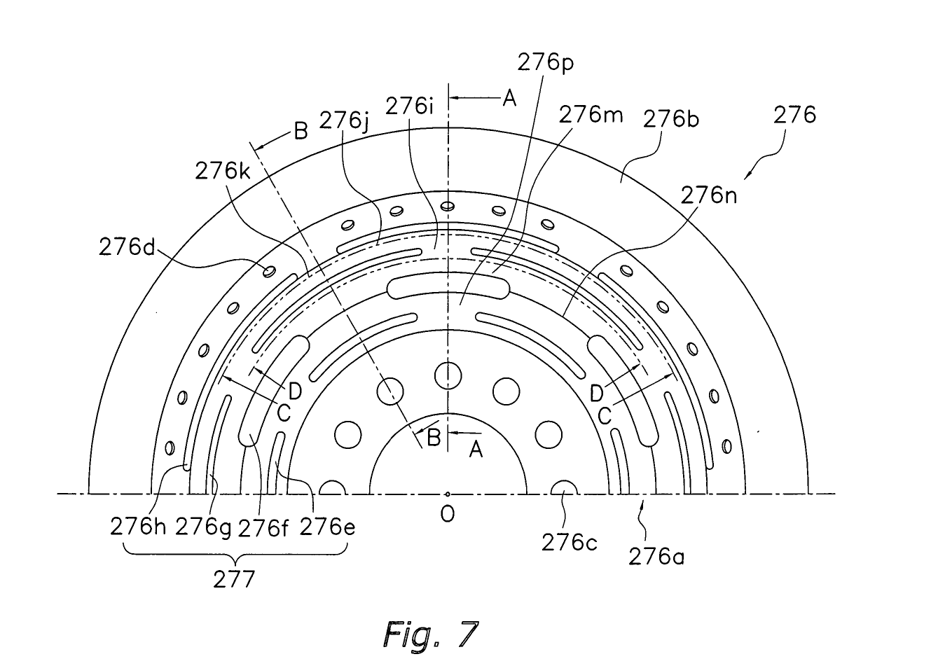

As shown in FIGS. 6 and 7, the inclination prevention mechanism 277 in this embodiment is formed of apertures 276e, apertures 276f, apertures 276g and apertures 276h formed in the body 276a. FIG. 7 is a view showing the transmission side of the coupling member 276.

The plurality of apertures 276e are arranged radially outside the fixing apertures 276c, and are aligned with each other in the rotational direction. The plurality of apertures 276f are arranged radially outside the apertures 276e, and each are located in a position circumferentially between the apertures 276e. The plurality of apertures 276g are arranged radially outside the apertures 276f, and each are located in a position circumferentially between the apertures 276f, and thus in the position corresponding to the radial position of the apertures 276e. The plurality of apertures 276h are arranged radially outside the apertures 276g, and each are located in the position circumferentially between the apertures 276g, and thus in the position corresponding to the apertures 276f. As described above, the body 276a is provided with the apertures 276e and 276g as well as the apertures 276f and 276h, which are arranged radially inside or outside the apertures 276e and 276g and are located in positions circumferentially between the apertures 276e and 276g, so that the apertures 276e, 276f, 276g and 276h, which are substantially adjacent to each other, are respectively arranged in staggered positions when viewed in the radial direction. In this embodiment, each of these apertures 276e-276f is formed of a slot or slit aperture that extends in the rotational direction.

More specifically, the aperture 276f has a center located in the circumferential position (i.e., in the position in the rotational direction) between the apertures 276e and 276g, and has circumferentially opposite ends overlapping in the radial direction with the circumferentially ends of the apertures 276e and 276g. Likewise, the aperture 276g arranged radially outside the apertures 276f has a center located in the circumferential position between the apertures 276f and 276h, and has the circumferentially opposite ends overlapping in the radial direction with the circumferentially ends of the apertures 276f and 276h. As described above, the circumferentially opposite ends of each of the apertures 276e-276f radially overlaps with the circumferentially opposite ends of the aperture (276e-276f) in the radially outer or inner position. The above arrangement provides portions (which will be referred to as “low-rigidity portions” hereinafter) each located radially between the circumferential ends of the radially neighboring apertures 276e-276f, and also provides portions (which will be referred to as “high-rigidity portions” hereinafter) each located radially between the circumferential centers of the radially neighboring apertures 276e-276f. This low-rigidity portion has a smaller rigidity than the high-rigidity portion, and therefore can axially bend to a greater extent than the high-rigidity portion when the pressure-contact portion 276b axially moves.

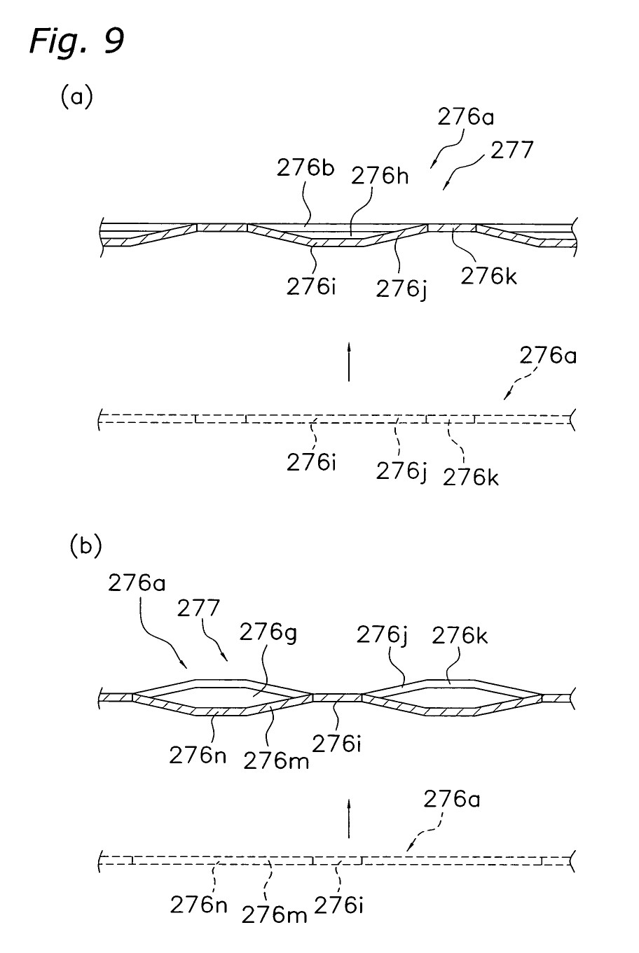

When the lockup device 207 is provided with the coupling member 276 having the inclination prevention mechanism 277 described above, and enters into the lockup state, the coupling member 276 operates as described below with reference to FIGS. 7 to 9. FIG. 8 schematically shows the operation of the coupling member 276 during a lockup operation, and (a), (b) and (c) in FIG. 8 correspond to the views of the coupling member 76 of the first embodiment not provided with the inclination prevention mechanism, which are taken along lines A-A, B-B and C-C in FIG. 7, respectively. FIG. 9 schematically shows an operation of the coupling member 276 in the lockup operation, and (a) and (b) in FIG. 9 show cross sections taken along lines C-C and D-D in FIG. 7, respectively.

When working fluid is discharged from the space 8a, the piston 75 moves axially toward the engine, and the pushing portion 75d of the piston 75 axially pushes the pressure-contact portion 276b of the coupling member 276 toward the engine so that the body 276a of the coupling member 276 bends axially toward the engine around the position of the fixing aperture 276c. In this operation, the inclination prevention mechanism 277 of the coupling member 276 utilizes the difference in bending between the low-rigidity portion and the high-rigidity portion, which is provided by the plurality of apertures 276e-276f, and thus keeps the attitude or position of the body 276a similar to that in the free state while the body 276a is being axially bent. Therefore, the pressure-contact portion 276b can axially move without inclining the pressure-contact portion 276b with respect to the frictional coupling portion 71a and the pushing portion 75d.

The operation of the inclination prevention mechanism 277 will now be described in greater detail with reference to the cross sections taken along lines C-C and D-D in FIG. 7.

When the pressure-contact portion 276b moves axially toward the engine, a portion of the body 276a near the section C-C operates as shown in FIGS. 8(b) and 9(a), and thus operates such that a plurality of high-rigidity portions 276k formed circumferentially between the plurality of apertures 276h axially move toward the engine in accordance with the axial movement of the pressure-contact portion 276b. The body 276a generally tends to bend axially around the position of the fixing aperture 276c so that low-rigidity portions 276j formed on the circumferential opposite sides of each high-rigidity portion 276k axially bend while axially deforming the portions of the apertures 276h between the high- and low-rigidity portions 276k and 276j. Thus, the portion of the body 276a near the section C-C axially bends, and the portion of the body 276a near the section C-C can axially bend while keeping the attitude or position of the high-rigidity portion 276k similar to that in the free state. Likewise, as shown in FIGS. 8(a) and 9(b), the portion near the section D-D of the body 276a operates such that the high-rigidity portions 276i formed circumferentially between the plurality of apertures 276g axially move toward the engine in accordance with the axial movement of the pressure-contact portion 276b. In this operation, low-rigidity portions 276m formed on the circumferential opposite sides of each high-rigidity portion 276i axially bend while axially deforming portions of the apertures 276g between the low- and high-rigidity portions 276m and 276n. Thus, the portion of the body 276a near the section D-D axially bends, and the portion of the body 276a near the section D-D can axially bend while keeping the attitude or position of the high-rigidity portion 276i similar to that in the free state. Furthermore, high-rigidity portions 276n and 276p formed radially inside the section D-D of the body 276a operate similar to the above operations, and therefore the portions of the body 276a corresponding to these high-rigidity portions can bend while keeping the positions or attitudes similar to those in the free state. As a whole, therefore, the body 276a can axially bend while keeping its attitude similar to that in the free state.

According to the lockup device 207 of this embodiment, because the inclination prevention mechanism 277 formed of the plurality of apertures 276e-276h can prevent inclination of the pressure-contact portion 276b with respect to the frictional coupling portion 71a and the pushing portion 75d during axial movement, it is possible to suppress the occurrence of drag torque between the pressure-contact portion 276b and the opposite members (i.e., the frictional coupling portion 71a or the pushing portion 75d), and to achieve a uniform pressure on the facing surfaces (i.e., to improve the μ-V characteristics). In the lockup device 207, the plurality of apertures 276e-276h are formed of slots or slit apertures, the rigidities of the low- and high-rigidity portions can be easily and appropriately determined by changing the circumferential length of the slit apertures.

(2) Modifications

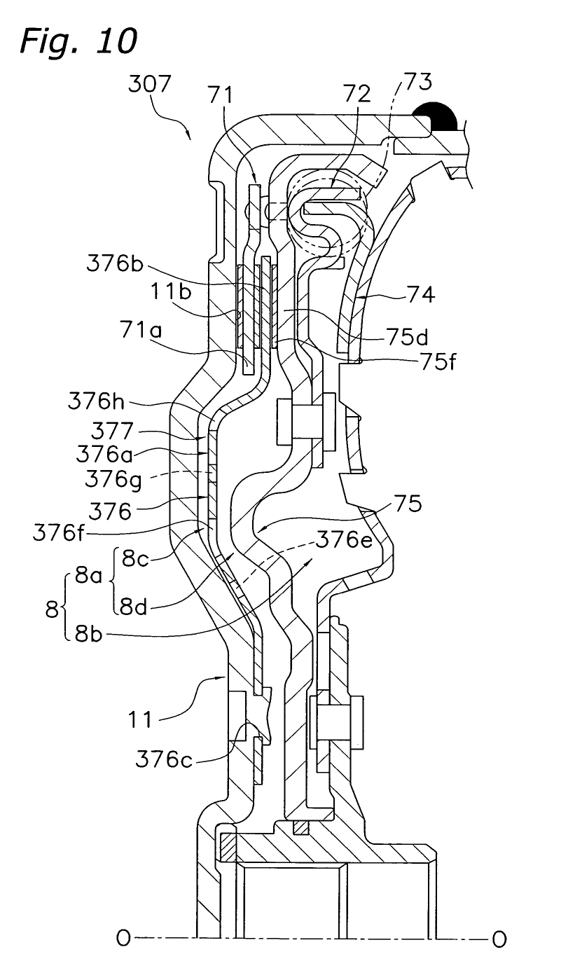

In the lockup device 207 of the foregoing embodiment, because the inclination prevention mechanism 277 formed of the plurality of apertures 276e-276h is arranged in the body 276a, these apertures 276e-276h can be used as oil apertures for communication between the spaces 8c and 8d. Therefore, the plurality of oil apertures 276d may be eliminated from the lockup device 207, as is done in a lockup device 307 shown in FIG. 10.

Third Embodiment

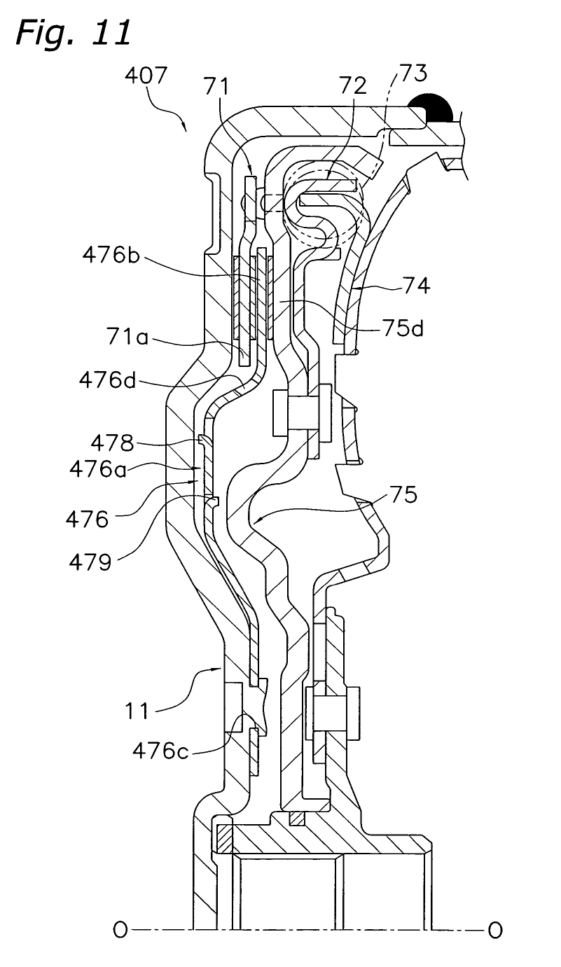

The lockup device 7 of the first embodiment may be provided with a restriction mechanism for restricting the axial bending of the body 76a of the coupling member 76. For example, a lockup device 407 of a third embodiment shown in FIG. 11 may be employed. The lockup device 407 is provided with cut and bent portions 478 and 479, which are prepared by partially cutting a body 476a of a coupling member 476 and axially bending the cut portions toward the engine and the transmission, respectively. These portions 478 and 479 form the restriction mechanism. Structures of the lockup device 407 other than the above are substantially the same as those of the lockup device 7 of the first embodiment, and therefore will not be described herein.

Owing to the provision of the cut and bent portions 478 and 479 in the body 476a, the end of the cut and bent portion 478 can come into contact with the inner surface of the front cover 11 when the body 476a bends axially toward the engine, and thus the axial bending of the body 476a of the coupling member 476 toward the engine can be limited within a predetermined range. In addition, the end of the cut and bent portion 479 can come into contact with the surface of the piston 75 on the engine side, and thus the axial bending of the body 476a of the coupling member 476 toward the transmission can be limited within the predetermined range. Therefore, the coupling member 476 can be prevented from interference with another member (the front cover 11, clutch plate 71, piston 75 or the like).

If only the bending of the coupling member 476 toward the piston 75 is to be restricted within a predetermined range, only the cut and bent portion 479 may be employed. Conversely, if only the bending toward the front cover 11 is to be restricted within a predetermined range, only the cut and bent portion 478 may be employed.

(1) Modification 1

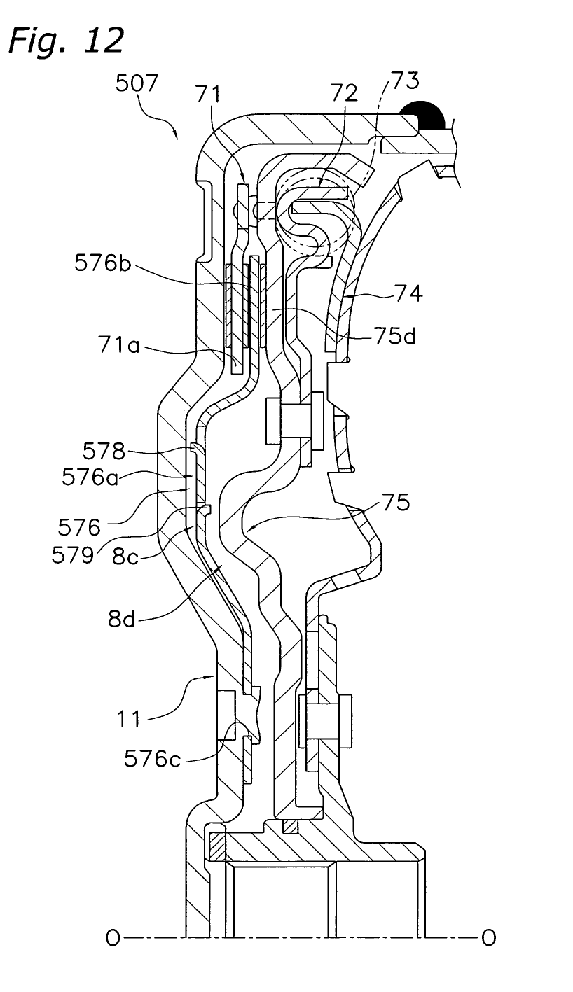

In the lockup device 407 of the foregoing embodiment, the limiting mechanism formed of the cut and bent portions 478 and 479 is provided in the body 476a, and thus the apertures connecting the spaces 8c and 8d are formed. Because these apertures can be utilized as oil apertures for connecting the spaces 8c and 8d, the plurality of oil apertures 476d may be eliminated from the lockup device 407, as is done in a lockup device 507 shown in FIG. 12.

(2) Modification 2

In the lockup device 207 of the second embodiment, the body 276a of the coupling member 276 is provided with the inclination prevention mechanism 277. The inclination prevention mechanism 277 is formed of the plurality of apertures 276e-276h in the body 276a. These apertures 276e-276h are formed by stamping as shown in FIG. 7, but may be formed by partially cutting and bending the portions toward the front cover or the piston in order to also use these bent portions as the restriction mechanism.

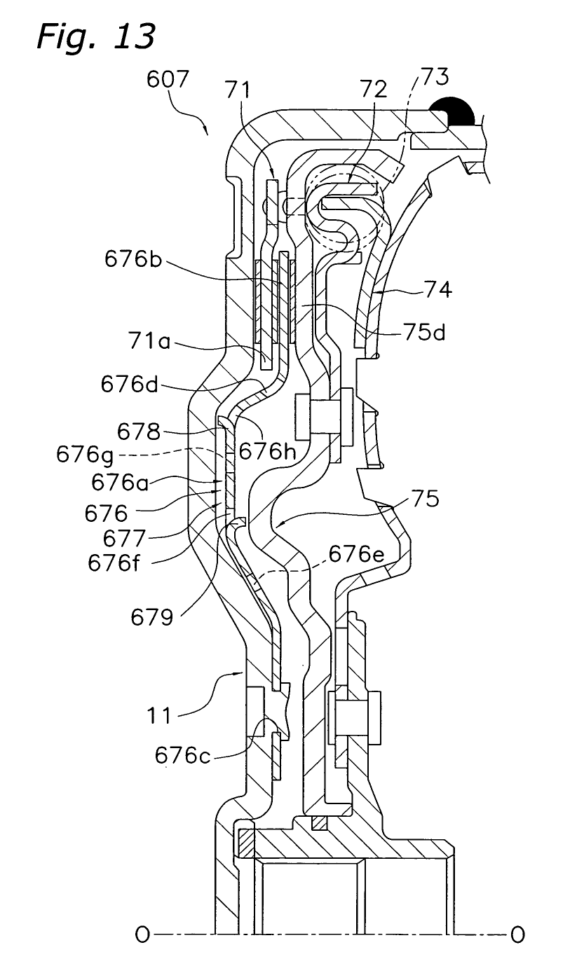

For example, a lockup device 607 shown in FIG. 13 may be employed. In the lockup device 607, a body 676a of a coupling member 676 is provided with an inclination prevention mechanism 677 formed of a plurality of apertures 676e-676h, similarly to the lockup device 207 of the second embodiment, but the apertures 676e and 676h are formed by partial cutting and bending instead of stamping. More specifically, the plurality of apertures 676h are formed by partially cutting and bending the body 676a axially toward the engine to form cut and bent portions 678. The plurality of apertures 676f are formed by partially cutting and bending the body 676a axially toward the transmission to form cut and bent portions 679.

Owing to the above structure of the coupling member 676, a pressure-contact portion 676b of the coupling member 676 is prevented from inclination during its axial movement, and the axial bending of the body 676a can be limited within a predetermined range.

Similarly to the lockup device 307 of the modification 1 of the second embodiment and the lockup device 507 of the modification 1 of this embodiment, the spaces 8c and 8d are connected together because the inclination prevention mechanism 677 and the cut and bent portions 678 and 679 have been provided. Therefore, the oil aperture 676d can be eliminated from the coupling member 676.

(3) Modification 3

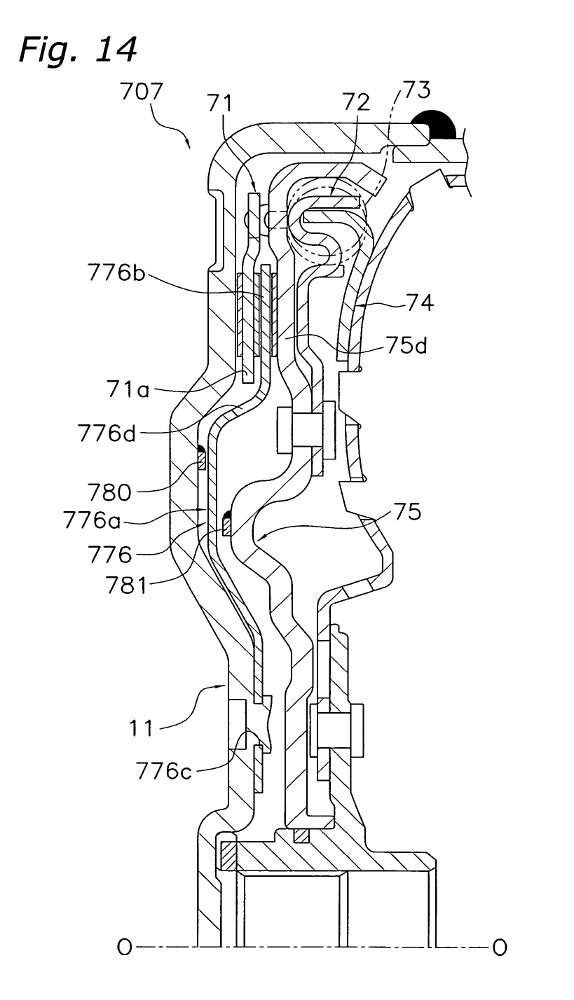

In the lockup devices 407, 507 and 607 of this embodiment, the cut and bent portions formed in the body of the coupling member serve as the limiting mechanism. However, as is done in a lockup device 707 shown in FIG. 14, lugs 780 and 781 may be provided at the inner surface of the front cover 11 and the surface on the engine side of the piston 75, respectively. The lugs 780 and 781 may be fixed to the front cover 11 and the piston 75 by welding or the like, or may be formed of projections integral with the front cover 11 and the piston 75, respectively.

Owing to the provision of the lugs 780 and 781 described above, a portion of a body 776a may come into contact with the lug plate 780 when the body 776a of the coupling member 776 axially bends toward the engine, and thus the axial bending of the body 776a toward the engine can be limited within a predetermined range. Also, by bringing a portion of the body 776a into contact with the lug plate 781, the axial bending of the body 776a toward the transmission can be limited within a predetermined range.

In the lockup device 707 of this modification, the body 776a may be provided with an inclination prevention mechanism, and thus an oil aperture 776d may be eliminated, similarly to the structures already described.

Fourth Embodiment

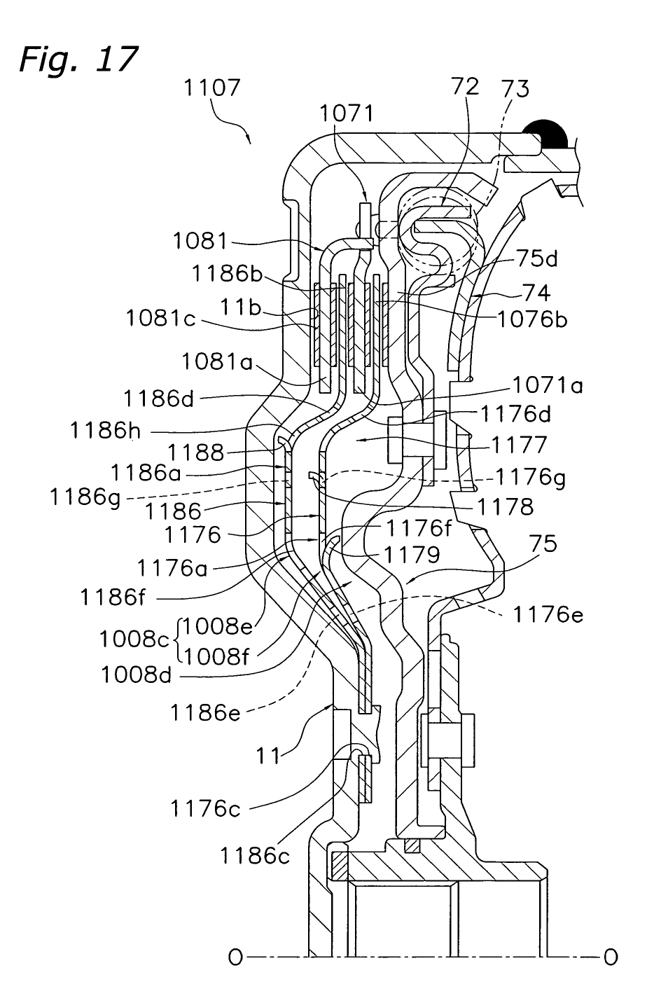

In the lockup device 7 of this embodiment, the clutch plate 71 is engaged with the engagement portions 75i of the piston 75, and the coupling member 76 functioning as the piston coupling mechanism is employed to provide the structure having three friction surfaces. However, the number of the friction surfaces may be further increased. For example, a lockup device 1007 of a fourth embodiment shown in FIG. 17 may be employed. In this structure, a clutch plate 1071 is engaged with the engagement portions 75i of the piston 75, and another clutch plate 1081 is axially movably and non-rotatably attached to the clutch plate 1071. In addition, another coupling member 1086 is arranged axially between the two clutch plates 1071 and 1081. Thus, this structure has five friction surfaces. The lockup device 1007 of this embodiment will now be described. The lockup device 1007 has basically the same structures as the lockup device 7. Therefore, the parts and portions corresponding to those in the first embodiment will not be described herein, but the different portions will be described.

(1) Structure of the Lockup Device

The clutch plate 1081 will now be described. The clutch plate 1081 is an annular plate member arranged on the engine side of the clutch plate 1071, and has an annular frictional coupling portion 1081a adjacent to the friction surface 11b of the front cover 11 and a plurality of claws 1081b formed radially outside the frictional coupling portion 1081a. An annular friction facing 1081c is fixed to the surface on the engine side of the frictional coupling portion 1081a. In this embodiment, an annular friction facing 1081d is attached to the surface on the transmission side of the frictional coupling portion 1081a. The claws 1081b axially extend toward the transmission.

The clutch plate 1071 is provided with claws 1071b formed radially outside the annular frictional coupling portion 1071a as shown in FIG. 18, and is further provided with recesses 1071e each located in or around a circumferential center (i.e., center in the rotational direction) of the claw 1071b. The claws 1081b are axially movably and non-rotatably engaged with the recesses 1071e of the clutch plate 1071.

The coupling member 1086 will now be described. The coupling member 1086 and the coupling member 1076 form a piston coupling mechanism for axially movably coupling the pushing portion 75d of the piston 75, frictional coupling portion 1071a of the clutch plate 1071 and the frictional coupling portion 1081a of the clutch plate 108 to the front cover 11.

The coupling member 1086 is arranged on the engine side of the coupling member 1076. The coupling member 1086 is an axially flexible plate member, similarly to the coupling member 1076, and is primarily formed of a body 1086a and a pressure-contact portion 1086b arranged axially between the frictional coupling portions 1071a and 1081a.

The body 1086a in this embodiment is an annular portion, which further divides a space 1008c located axially between the front cover 11 and the coupling member 1076 into two spaces 1008e and 1008f located on the engine side and the transmission side, respectively. The body 1086a has a plurality of fixing apertures 1086c and a plurality of oil apertures 1086d. The fixing apertures 1086c are formed in the inner peripheral portion of the body 1086a. The coupling member 1086 is fixed together with the coupling member 1076 to the front cover 11 by caulking effected in the positions of the fixing apertures 1086c, and thus can rotate together with the front cover 11. The oil apertures 1086d are provided for continuously allowing working fluid to flow between the spaces 1008e and 1008f, and are formed in the radially outer portion of the body 1086a in this embodiment.

The pressure-contact portion 1086b is an annular portion formed radially outside the body 1086a, and is arranged axially between the surface on the transmission side of the frictional coupling portion 1081a of the clutch plate 1081 and the frictional coupling portion 1071a of the clutch plate 1071 (more specifically, the friction facing 1071c). The pressure-contact portion 1086b axially bends around the position of the fixing aperture 1086c, and thus can axially move.

As described above, the coupling member 1086 is non-rotatable with respect to the front cover 11. In addition, in accordance with the axial movement of the pushing portion 75d of the piston 75 and the frictional coupling portions 1071a and 1081a of the two clutch plates 1071 and 1081, the coupling member 1086 axially moves and is pressed between the two frictional coupling portions 1071a and 1081a so that it can couple the piston 75 to the front cover 11.

As described above, the two clutch plates 1071 and 1081 as well as the pushing portion 75d of the piston 75 and the two coupling members 1076 and 1086 form the clutch mechanism of the lockup device 1007 for frictionally coupling the front cover 11 to the piston 75.

(2) Operation of the Lockup Device

The lockup operation of the lockup device 1007 will now be described.

When the working fluid is discharged from a space 1008a to axially move the piston 75 toward the engine, the pushing portion 75d of the piston 75 axially pushes a pressure-contact portion 1076b of the coupling member 1076 toward the engine. Thus, a body 1076a of the coupling member 1076 axially bends toward the engine around the position of a fixing aperture 1076c, the pressure-contact portion 1076b of the coupling member 1076 axially moves toward the engine, and comes into contact with the frictional coupling portion 1071a of the clutch plate 1071 so that it is axially held between the pushing portion 75d and the frictional coupling portion 1071a. Then, the pushing portion 75d of the piston 75, which is holding the pushing portion 75d between it and the frictional coupling portion 1071a, axially pushes the frictional coupling portion 1071a toward the engine so that the frictional coupling portion 1071a axially pushes the pressure-contact portion 1086b of the coupling member 1086 toward the engine. Thus, the body 1086a of the coupling member 1086 axially bends around the position of the fixing aperture 1086c, the pressure-contact portion 1086b of the coupling member 1086 axially moves toward the engine and comes into contact with the frictional coupling portion 1081a of the clutch plate 1081 so that it is held between the two frictional coupling portions 1071a and 1081a. Furthermore, the pushing portion 75d of the piston 75, which holds the pressure-contact portions 1076b and 1086b and the frictional coupling portion 1071a between it and the frictional coupling portion 1081a, axially pushes the frictional coupling portion 1081a toward the engine so that the frictional coupling portion 1081a is pressed against the friction surface 11b of the front cover 11. The lockup operation is performed in this manner.

In the above operation, the clutch plate 1081 is axially movably and non-rotatably engaged with the concavities 1071e of the clutch plate 1071, and therefore can move smoothly in the axial direction. Because the coupling member 1086 rotates together with the front cover 11, it operates together with the coupling member 1076 to transmit the torque to the clutch plates 1071 and 1081 and the piston 75. The torque transmitted from the front cover 11 to the piston 75 is transmitted to the turbine 22 through the damper mechanism (i.e., the drive plate 72, torsion springs 73 and driven plate 74), and is directly provided to the input shaft (not shown).

Because the body 1086a of the coupling member 1086 is provided with the oil apertures 1086d similarly to the coupling member 1076, a flow of working fluid is ensured between the spaces 1008e and 1008f, and the pressures in these spaces 1008e and 1008f are equalized. Thus, working fluid can be smoothly discharged from the space 1008c (more specifically, spaces 1008e and 1008f) during the lockup operation.

Release of the lockup state will now be described. In the lockup releasing operation, the pressure in the space 1008a will exceed the pressure in the space 1008b, and will axially move the piston 75 toward the transmission. Thus, the piston 75 moves until the end on the turbine side of the radially inner cylindrical portion 75c comes into contact with the surface on the engine side of the flange 32a of the turbine hub 32. Because the pressure-contact portions 1076b and 1086b of the coupling members 1076 and 1086 are released from the axial pushing force directed toward the engine side, the pressure-contact portions 1076b and 1086b axially move toward the transmission, and the bodies 1076a and 1086a, which have been axially bent toward the engine, return to the unbent free state.

In the above lockup releasing operation, working fluid can be smoothly supplied into the space 1008c because the oil apertures 1086d are formed in the body 1086a of the coupling member 1086 similar to the coupling member 1076.

The lockup device 1007 of this embodiment includes the clutch plate 1081 in addition to the clutch plate 1071, and thus has the five friction surfaces. Therefore, the torque transmission capacity is further increased.

(3) Modification

As shown in FIG. 17, the coupling members 1076 and 1086 of the lockup device 1007 of this embodiment may be provided with inclination prevention mechanisms 1177 and 1187 similar to the inclination prevention mechanism 277 provided in the coupling member 276 of the lockup device 207 of the second embodiment, respectively.

The coupling members 1076 and 1086 may be provided with cut and bent portions similar to the cut and bent portions 478 and 479 provided in the lockup device 407 of the third embodiment for forming the limiting mechanism. For example, a lockup device 1107 shown in FIG. 17 may be employed. In this structure, a body 1176a of a coupling member 1176 is provided with the inclination prevention mechanism 1177 formed of apertures 1176e-1176h. The apertures 1176g and 1176f are formed by forming partially cut and bent portions 1178 and 1179, respectively. Furthermore, a body 1186a of a coupling member 1186 is provided with the inclination prevention mechanism 1187 formed of apertures 1186e-1186h, and the aperture 1186h is formed by forming a partially cut and bent portion 1188. This structure can prevent the coupling members 1176 and 1186 from interfering with each other.

Further, in the lockup device 1107 of this modification, oil apertures 1176d and 1186d in the coupling members 117 and 1186 may be eliminated.

Other Embodiments

The embodiments of the invention have been described with reference to the drawings. However, various modifications and variations can be effected without departing from the spirit and scope of the invention.

(1) In the embodiments described above, the lockup device of the present invention is applied to a torque converter. However, the present invention can be applied to other hydrodynamic torque transmitting devices such as a fluid coupling.

(2) The structure of the damper coupling mechanism of the lockup device is not restricted to those in the foregoing embodiments, and other structures may be employed.

(3) The structure for engagement between the clutch plate and the piston is not restricted to the engagement structures in the foregoing embodiments, and other structures may be employed.

Any terms of degree used herein, such as “substantially”, “about” and “approximately”, mean a reasonable amount of deviation of the modified term such that the end result is not significantly changed. These terms should be construed as including a deviation of at least ±5% of the modified term if this deviation would not negate the meaning of the word it modifies.

This application claims priority to Japanese Patent Application Nos. 2003-126562, 2003-129271, and 2003-131857. The entire disclosure of Japanese Patent Application Nos. 2003-126562, 2003-129271, and 2003-131857 are hereby incorporated herein by reference.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing description of the embodiments according to the present invention are provided for illustration only, and not for the purpose of limiting the invention as defined by the appended claims and their equivalents.

What is claimed is:

1. A lockup device for a hydrodynamic torque transmitting device that includes a front cover having a friction surface, an impeller fixed to the front cover to form a fluid chamber filled with working fluid, and a turbine arranged in the fluid chamber and opposed to the impeller, the lockup device comprising:
a piston arranged between the front cover and the turbine, the piston including a pushing portion opposed to the friction surface, and being axially movable in accordance with a pressure of the working fluid;
a first clutch member including a first frictional coupling portion attached axially movably and non-rotatably to the piston, and arranged axially between the friction surface and the pushing portion; and
an annular first coupling member including a first unit fixed to the front cover and being axially flexible, and a first pressure-contact portion provided at a radial end of the first unit and located axially between the first frictional coupling portion and the pushing portion.

2. The lockup device of the hydrodynamic torque transmitting device according to claim 1, wherein
the first unit is fixed to the front cover by caulking.

3. The lockup device of the hydrodynamic torque transmitting device according to claim 1, wherein
the first coupling member includes an inclination prevention mechanism that allows axial movement of the first pressure-contact portion without inclination with respect to the first frictional coupling portion and the pushing portion.

4. The lockup device of the hydrodynamic torque transmitting device according to claim 3, wherein
the inclination prevention mechanism includes a plurality of first apertures formed in the first unit and aligned in a rotational direction, and a plurality of second apertures formed in the first unit and aligned in the rotational direction; and
the plurality of second apertures are located radially inside or outside the plurality of first apertures, each have a center in the rotational direction located between the first apertures in the rotational direction, each have opposite ends in the rotational direction that overlap in a radial direction of the device with the ends in the rotational direction of the first apertures, and are located such that the first and second apertures are located in alternating positions with respect to the radial direction.

5. The lockup device of the hydrodynamic torque transmitting device according to claim 4, wherein
the first and second apertures are slit apertures each extending in the rotational direction.

6. The lockup device of the hydrodynamic torque transmitting device according to claim 1, further comprising:
a restriction mechanism that allows the first unit to bend axially only within a predetermined range.

7. The lockup device of the hydrodynamic torque transmitting device according to claim 1, further comprising:
a second clutch member attached axially movably and non-rotatably to the first clutch member, and including a second frictional coupling portion arranged axially between the first frictional coupling portion and the friction surface; and
an annular second coupling member including an axially flexible second unit fixed to the front cover, and a second pressure-contact portion provided at a radial end of the second unit and located axially between the first and second frictional coupling portions.

8. The lockup device of the hydrodynamic torque transmitting device according to claim 7, wherein
the second unit is fixed to the first unit and the front cover by caulking.

9. A lockup device for a hydrodynamic torque transmitting device that includes a front cover including a friction surface, an impeller fixed to the front cover to form a fluid chamber filled with working fluid, and a turbine arranged in the fluid chamber and opposed to the impeller, the lockup device comprising:
a piston arranged between the front cover and the turbine and axially movable in response to pressure from the working fluid, the piston including a pushing portion opposed to the friction surface;
a first clutch member including a portion located radially outside the pushing portion and attached axially movably and non-rotatably to the piston, and a first frictional coupling portion arranged axially between the friction surface and the pushing portion;
a piston coupling mechanism arranged at the front cover to divide a space located axially between the front cover and the piston into a first working fluid chamber on a front cover side and a second working fluid chamber on a piston side, the piston coupling mechanism including an axially movable first pressure-contact portion arranged axially between the first frictional coupling portion and the pushing portion that axially movably couples the pushing portion and the first frictional coupling portion to the front cover; and
a pressure control mechanism that equalizes the pressures in the first and second working fluid chambers.

10. The lockup device of the hydrodynamic torque transmitting device according to claim 9, wherein
the pressure control mechanism is an oil passage provided in the piston coupling mechanism that serves to connect the first and second working fluid chambers to each other.

11. The lockup device of the hydrodynamic torque transmitting device according to claim 9, further comprising:
a second clutch member attached axially movably and non-rotatably to the first clutch member, and including a second frictional coupling portion arranged axially between the first frictional coupling portion and the friction surface; and
the piston coupling mechanism further includes an axially movable second pressure-contact portion arranged axially between the first and second frictional coupling portions, and further divides the first working fluid chamber into a third working fluid chamber on the front cover side and a fourth working fluid chamber on the piston side, and
the pressure control mechanism can equalize pressures in the third, fourth and second working fluid chambers.

12. A lockup device for a hydrodynamic torque transmitting device including a front cover including a friction surface, an impeller fixed to the front cover and forming a fluid chamber filled with working fluid, and a turbine arranged in the fluid chamber and opposed to the impeller, the lockup device comprising:
a piston arranged between the front cover and the turbine and axially movable in response to pressure from the working fluid, the piston including a pushing portion opposed to the friction surface and engagement portions projecting toward the front cover from a portion radially outside the pushing portion;
a damper mechanism arranged on the turbine side of the piston for elastically coupling the turbine and the piston together;
a first clutch member axially movably and non-rotatably engaged with the engagement portion, and including a first frictional coupling portion arranged axially between the friction surface and the pushing portion; and
a piston coupling mechanism provided at the front cover, the piston coupling mechanism including an axially movable first pressure-contact portion arranged axially between the first frictional coupling portion and the pushing portion, and axially movably coupling the pushing portion and the first frictional coupling portion to the front cover.

13. The lockup device of the hydrodynamic torque transmitting device according to claim 12, wherein
the damper mechanism has a drive plate fixed to the piston, a driven plate arranged for rotation with the turbine, and elastic members supported by a surface on the turbine side of the piston and compressible in a rotational direction between the drive and driven plates, and
the engagement portions are formed to correspond to radial positions of portions of the elastic members supported by the piston.

14. The lockup device of the hydrodynamic torque transmitting device according to claim 12, wherein
the engagement portions are respectively formed in a plurality of positions aligned in the rotational direction.

15. The lockup device of the hydrodynamic torque transmitting device according to claim 12, further comprising:
a second clutch member attached axially movably and non-rotatably to the first clutch member, and including a second frictional coupling portion arranged axially between the first frictional coupling portion and the friction surface; and
the piston coupling mechanism further includes an axially movable second pressure-contact portion arranged axially between the first and second frictional coupling portions.
